(19) United States
(12) Patent Application Publication
(10) Pub. No.: US 2020/0327283 A1
(43) Pub. Date: Oct. 15, 2020

(54) INFORMATION PROCESSING APPARATUS, COMPUTER PROGRAM PRODUCT, AND COMPUTER READABLE MEDIUM

(71) Applicant: FUJITSU CLIENT COMPUTING LIMITED, Kanagawa (JP)

(72) Inventor: Toshiro Ohbitsu, Kawasaki (JP)

(73) Assignee: FUJITSU CLIENT COMPUTING LIMITED, Kanagawa (JP)

(21) Appl. No.: 16/804,113

(22) Filed: Feb. 28, 2020

(30) Foreign Application Priority Data
Apr. 9, 2019 (JP) 2019-074200

(51) Int. Cl. G06F 40/30; H04L 12/58

(52) U.S. Cl. CPC G06F 40/30; H04L 51/16

(57) ABSTRACT

An information processing apparatus includes a processor that: acquires one or more remarks included in a conversation; determines whether a predetermined expression is included in the one or more remarks of one or more users participating in the conversation; in response to a determination that the predetermined expression is included in a remark, converts, based on environment information and conversion information, a word included in the remark into one or more specifying-purpose expressions, the environment information indicating an environment of the conversation, the conversion information defining a conversion rule for a word according to the environment information for each of the one or more users; specifies content based on the one or more specifying-purpose expressions; and outputs a specification result of the content.

### CROSS-REFERENCE TO RELATED APPLICATIONS

This application is based upon and claims the benefit of priority from Japanese Patent Application No. 2019-074200, filed Apr. 9, 2019, the entire contents of which are incorporated herein by reference.

### TECHNICAL FIELD

Embodiments described herein relate generally to an information processing apparatus, a computer program product, and a computer readable medium.

### BACKGROUND

Conventionally, in social networking service (SNS), etc., there has been a used technology in which a plurality of users performs communication such as chat in real time. In addition, there has been disclosed a technology in which a program that automatically performs communication in place of a human being responds to a user by text or voice. For example, in SNS, etc., there has been a known technology of a chatbot for executing a text conversation with a user.

In addition, there has been a known technology in which a chatbot, etc. specifies information by searching or investigation based on conversation with a user and displays a specification result on a screen or responds by voice.

However, in the related art, it has been difficult to specify information desired by a user with high accuracy in some cases.

### SUMMARY

According to an aspect of the present invention, an information processing apparatus includes processing circuitry (i.e., processor) configured to implement an acquisition unit, a determination unit, a conversion unit, a specification unit, and an output unit. The acquisition unit acquires one or more remarks included in a conversation. The determination unit that determines whether or not a predetermined expression is included in the one or more remarks of one or more users participating in the conversation. The conversion unit, in response to a determination that the predetermined expression is included in a remark of the one more remarks, converts, based on environment information and conversion information, a word included in the remark into one or more specifying-purpose expressions, the environment information indicating an environment of the conversation, the conversion information defining a conversion rule for a word according to the environment information for each of the one or more users. The specification unit that specifies content based on the one or more specifying-purpose expressions. The output unit outputs a specification result of the content.

According to another aspect of the present invention, a computer program product includes programmed instructions embodied in and stored on a non-transitory computer readable medium. The instructions, when executed by a computer, cause the computer to perform: acquiring one or more remarks included in a conversation; determining whether or not a predetermined expression is included in the one or more remarks of one or more users participating in the conversation; in response to a determination that the predetermined expression is included in a remark of the one or more remarks, converting, based on environment information and conversion information, a word included in the remark into one or more specifying-purpose expressions, the environment information indicating an environment of the conversation, the conversion information defining a conversion rule for a word according to the environment information for each of the one or more users; specifying content based on the one or more specifying-purpose expressions; and outputting a specification result of the content.

According to still another aspect of the present invention, a non-transitory computer readable medium stores a data structure of conversion information. The data structure is used in a computer including processing circuitry configured to implement a controller and the non-transitory computer readable medium. In the data structure, a conversion target expression, environment information indicating an environment of a conversation of one or more users, and one or more specifying-purpose expressions used for specifying content are associated with each of the one or more users. The data structure is used in a process in which the controller acquires, from the non-transitory computer readable medium, a specifying-purpose expression associated with a combination of the conversion target expression and the environment information, the combination matching a combination of a word included in a remark of the one or more users participating in the conversation and environment information indicating an environment of the conversation.

### BRIEF DESCRIPTION OF THE DRAWINGS

FIG. 1 is a diagram illustrating an example of an overall configuration of a chat system according to an embodiment;

FIG. 2 is a diagram illustrating an example of user information according to the embodiment;

FIG. 3 is a diagram illustrating an example of processing request information according to the embodiment;

FIG. 4 is a diagram illustrating an example of conversion information of a user “a” according to the embodiment;

FIG. 5 is a diagram illustrating an example of conversion information of a user c according to the embodiment;

FIG. 6 is a diagram illustrating an example of content information of the user “a” according to the embodiment;

FIG. 7 is a flowchart illustrating an example of a flow of a response process according to the embodiment;

FIG. 8 is a diagram illustrating an example of a chat according to the embodiment; and

FIG. 9 is a flowchart illustrating an example of a flow of a conversion process according to the embodiment.

### DETAILED DESCRIPTION

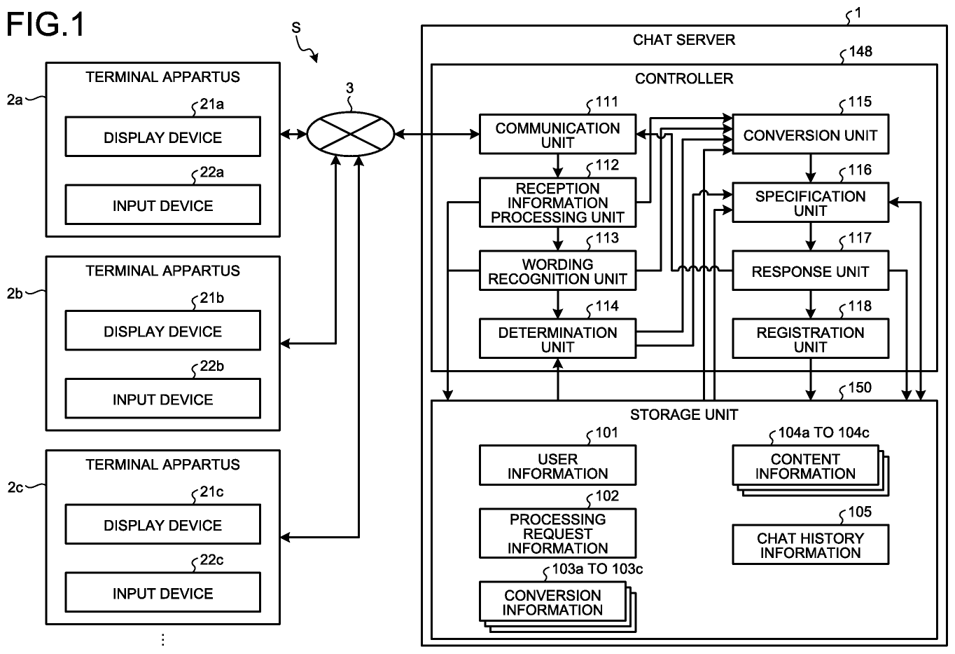

FIG. 1 is a diagram illustrating an example of an overall configuration of a chat system S according to the present embodiment. As illustrated in FIG. 1, the chat system S includes a chat server 1 and a plurality of terminal apparatuses 2a, 2b, 2c, etc.

For example, the plurality of terminal apparatuses 2a and 2b corresponds to a personal computer (PC), a smartphone, a tablet terminal, etc. Hereinafter, when the terminal apparatus 2a and the terminal apparatus 2b are not particularly distinguished, each of the terminal apparatuses is simply referred to as a terminal apparatus(es) 2. The number of terminal apparatuses 2 included in the chat system S is not particularly limited.

In addition, the terminal apparatus 2 includes a control device having a hardware processor such as a central processing unit (CPU), a storage device or a main storage device such as a read only memory (ROM) or a random access memory (RAM), an external storage device or an auxiliary storage device such as a hard disk drive (HDD) or a flash memory, display devices 21a and 21b (hereinafter, simply referred to as a display device 21 when not particularly distinguished), and input devices 22a and 22b (hereinafter, simply referred to as an input device 22 when not particularly distinguished), and has a hardware configuration using a normal computer. For example, the display device 21 corresponds to a display, etc. and is also referred to as a display unit. In addition, for example, the input device 22 corresponds to a keyboard, a mouse, a touch panel, etc., and is also referred to as an operation unit.

The chat server 1 is a server device that can be connected to the terminal apparatus 2 via a network 3 such as the Internet. The chat server 1 includes, for example, a control device having a hardware processor such as a CPU, a storage device or a main storage device such as a ROM or a RAM, and an external storage device or an auxiliary storage device such as an HDD or a flash memory, and has a hardware configuration using a normal computer. The chat server 1 is an example of an information processing apparatus according to the present embodiment.

The chat server 1 provides a chat service to the user using each of the plurality of terminal apparatuses 2. Specifically, in the chat system S of the present embodiment, the user of each of the plurality of terminal apparatuses 2 and the chat server 1 have a text conversation. In the present embodiment, simply “conversation” means a conversation using characters via the network 3, that is, a conversation in a text chat. Hereinafter, text chat is simply referred to as chat. In the present embodiment, a conversation (chat) includes one or more remarks.

Next, a functional configuration of the chat server 1 will be described. The chat server 1 includes a controller (e.g., processor) 148 and a storage unit 150. The controller 148 includes a communication unit 111, a reception information processing unit 112, a wording recognition unit 113, a determination unit 114, a conversion unit 115, a specification unit 116, a response unit 117, and a registration unit 118.

The storage unit 150 stores user information 101, processing request information 102, conversion information 103a to 103c (hereinafter, simply referred to as conversion information 103 when the conversion information 103a to 103c is not particularly distinguished), content information 104a to 104c (hereinafter, simply referred to as content information 104 when the content information 104a to 104c is not particularly distinguished), and chat history information 105. The storage unit 150 is, for example, a storage device such as an HDD.

The user information 101 is information of the user who uses the chat service, and is used as authentication information when the user logs in.

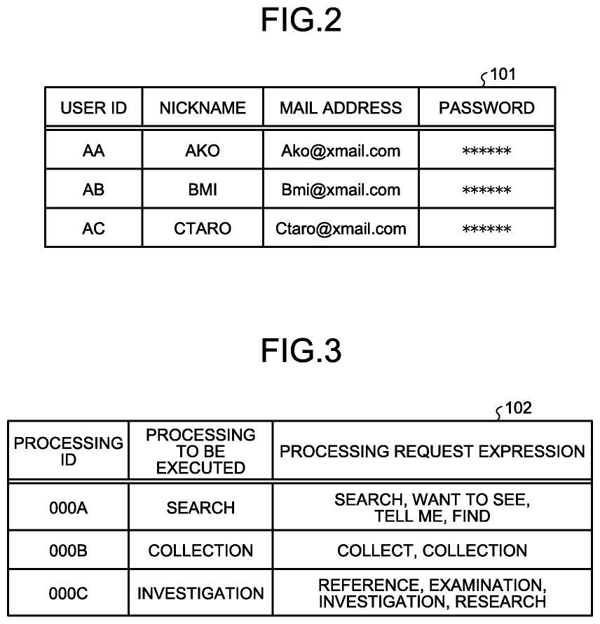

FIG. 2 is a diagram illustrating an example of the user information 101 according to the present embodiment. As illustrated in FIG. 2, for example, the user information 101 corresponds to information in which a user ID capable of specifying the user, a nickname of the user, a mail address, a password, etc. are associated with each other. Note that the user information 101 illustrated in FIG. 2 is an example, and the user information 101 may further include information such as a user address.

Hereinafter, in the present embodiment, for convenience, a user of a user ID “AA” is referred to as a “user a”, a user of a user ID “AB” is referred to as a “user b”, and a user of a user ID “AC” is referred to as a “user c”. In addition, the user a, the user b, and the user c use the terminal apparatus 2a, the terminal apparatus 2b, and the terminal apparatus 2c, respectively.

Returning to FIG. 1, the processing request information 102 corresponds to information in which a word including an intention of a request to start a content specification process is associated with a type of the content specification process.

FIG. 3 is a diagram illustrating an example of the processing request information 102 according to the present embodiment. As illustrated in FIG. 3, as an example, the processing request information 102 corresponds to information in which a processing ID, processing to be executed, and a processing request expression are associated with each other.

The processing ID corresponds to identification information that can specify processing to be executed.

In addition, processing to be executed is processing that can be executed by the chatbot in response to a request from the user, and corresponds to, for example, “search”, “collection”, “investigation”, etc. Note that in the present embodiment, all “search”, “collection”, and “investigation” correspond to search processing for the content information 104 described later, and may correspond to different processing content items.

Further, the processing request expression corresponds to a expression expected to be spoken in the chat when the user requests execution of any processing, and corresponds to a expression indicating, for example, a request for any one of “search”, “collection”, and “investigation”. The processing request expression may correspond to a word or a phrase in which a plurality of words is combined. The processing request expression is an example of a predetermined expression in the present embodiment.

In the example illustrated in FIG. 3, examples of the processing request expression associated with processing to be executed “search” include “search”, “want to see”, “tell me”, “find”, etc. In other words, the processing request expression such as “search”, “want to see”, “tell me”, “find”, etc. is a expression corresponding to a trigger for a start of a “search” process.

The configuration of the processing request information 102 illustrated in FIG. 3 is an example, and the invention is not limited thereto. For example, even though a name of processing to be executed is registered in the processing request information 102 in FIG. 3, only the processing ID may be registered. In addition, the processing ID may not be registered in the processing request information 102.

Returning to FIG. 1, the conversion information 103 corresponds to information in which a conversion rule for converting a word included in a remark of a chat user according to environment information is defined for each user. More specifically, the conversion information 103 corresponds to information in which a conversion target expression, environment information, and one or more specifying-purpose expressions are associated for each of one or more users. The configuration of the conversion information 103 is an example of a data structure in the present embodiment.

In the present embodiment, the conversion information 103 is generated as an individual database for each chat user. In the example illustrated in FIG. 1, since users of the chat correspond to three people of the user a, the user b, and the user c, three pieces of conversion information 103a to 103c are registered in the storage unit 150.

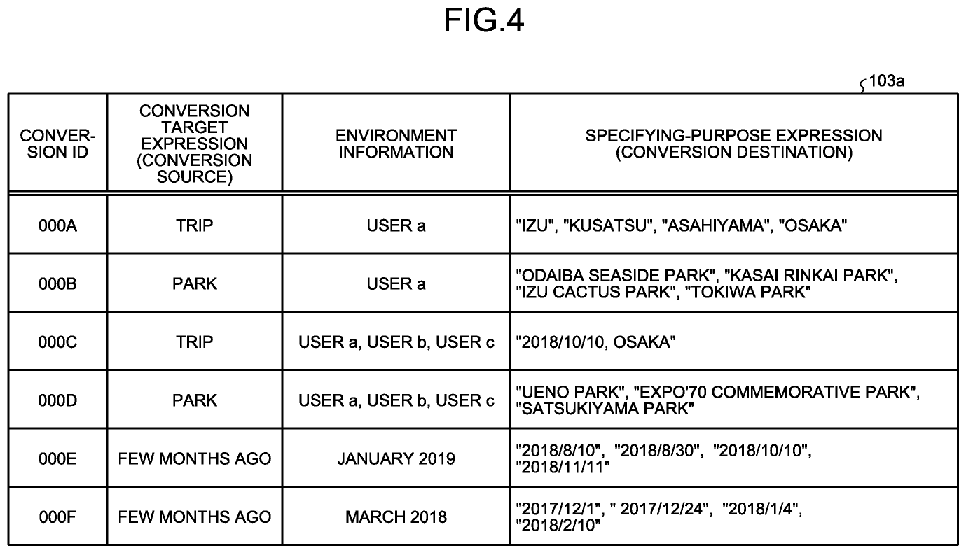

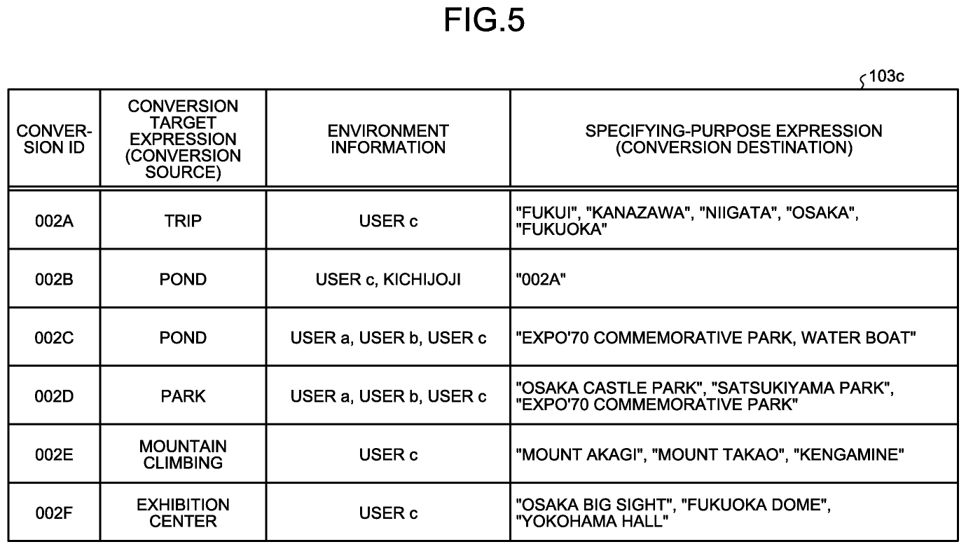

Details of the conversion information 103 will be described with reference to FIG. 4 and FIG. 5. FIG. 4 is a diagram illustrating an example of the conversion information 103a of the user “a” according to the present embodiment. In addition, FIG. 5 is a diagram illustrating an example of the conversion information 103c of the user c according to the present embodiment. As illustrated in FIG. 4 and FIG. 5, in the conversion information 103, for example, a conversion ID, environment information, a conversion target expression, and one or more specifying-purpose expressions are associated with each other.

The conversion ID corresponds to identification information capable of specifying a combination of a conversion target expression, environment information, and one or more specifying-purpose expressions. In addition, the conversion ID may correspond to a record number of a database, etc.

The conversion target expression corresponds to a word or a phrase to be converted into a specifying-purpose expression among words or phrases included in a remark of a chat user.

The environment information corresponds to information indicating an environment of the chat, for example, a combination of users participating in the chat, a date on which the chat is performed, a current position of the user of the chat, a past remark in the chat, etc. For example, the environment information “user a, user b, user c” indicates that chat participating members are three people of the user a, the user b, and the user c. In FIG. 4 and FIG. 5, each user is described as “user a”, etc. However, a user ID “AA”, etc. of the user may be registered in the environment information. In addition, for example, the environment information “January 2019” indicates that the date on which the chat is performed is January 2019.

The specifying-purpose expression is a word or a phrase used for specifying content desired by the chat user. For example, the specifying-purpose expression is used as a search condition for searching for content by the specification unit 116 described later. The specifying-purpose expression may be, for example, a word of a lower concept of the conversion target expression or a synonym.

In the examples illustrated in FIG. 4 and FIG. 5, a plurality of words separately written by commas in double quotes correspond to a search condition of an AND condition, and a plurality of words separately written by double quotes correspond to a search condition of an OR condition. However, the description example is merely an example, and the AND condition and the OR condition may be distinguished by another method.

Further, the specifying-purpose expression is associated with a combination of the conversion target expression and the environment information. In the example illustrated in FIG. 4, a specifying-purpose expression “2018/10/10, Osaka” is associated with a combination of a conversion target expression “trip” and environmental information “user a, user b, user c”. In this case, a conversion destination of a word “trip” included in a remark of the user a in the chat in which three users “user a, user b, and user c” participate corresponds to a conversion target expression “2018/10/10, Osaka”. As in the case of conversion IDs “000A” and “000C” illustrated in FIG. 4, even when the conversion target expressions are the same, if the environmental information is different, different specifying-purpose expression may be associated.

Further, in the example illustrated in FIG. 4, a specifying-purpose expression “2018/8/10”, “2018/8/30”, “2018/10/10”, “2018/11/11” is associated with a combination of a conversion target expression “few months ago” and environmental information “January 2019”. In this case, a conversion destination of the words “few months ago” included in the remark of the user a in the chat performed in “January 2019” corresponds to a conversion target expression “2018/8/10”, “2018/8/30”, “2018/10/10”, or “2018/11/11”.

For example, the conversion information 103 is registered by the chat user.

Returning to FIG. 1, the content information 104 corresponds to information in which content of each chat user, tag information (main), and tag information (sub) are associated for each chat user. In the example illustrated in FIG. 1, since chat users correspond to three people of the user a, the user b, and the user c, three pieces of content information 104a to 104c are registered in the storage unit 150. The content registered in the content information 104 is content that each user is permitted to share with other users.

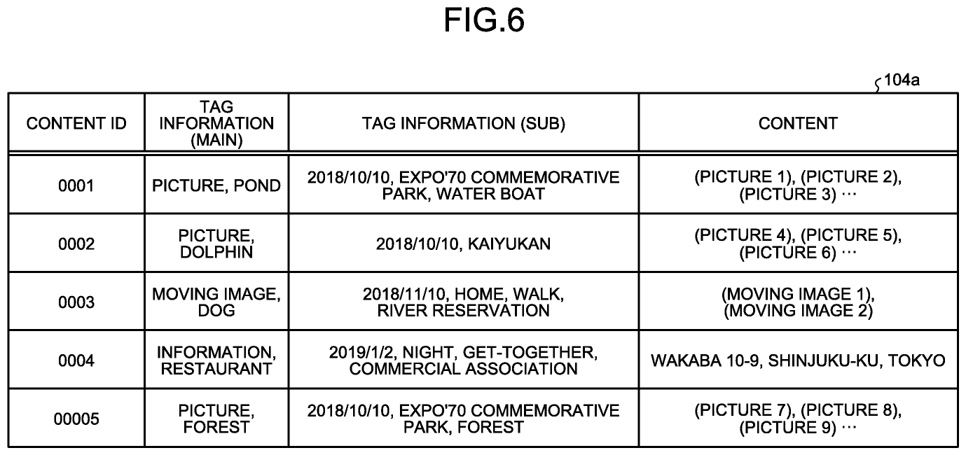

FIG. 6 is a diagram illustrating an example of the content information 104a of the user a according to the present embodiment. In the example illustrated in FIG. 6, in the content information 104a of the user a, a content ID, tag information (main), tag information (sub), and content are associated with each other.

The content ID corresponds to identification information that can specify one content or a combination of a plurality of content items. Further, the content ID may correspond to a record number of a database, etc.

The content includes a picture (image), a moving image, music, character information (character string), etc. However, the content is not limited thereto. For example, the content is registered in the chat server 1 from the terminal apparatus 2 of the user.

The tag information (main) corresponds to, for example, a content type, metadata, or a title. The tag information (main) may include all of the metadata of the content or may include only a part of the metadata. Further, when the content corresponds to the character information, the user may set an arbitrary word serving as tag information (main) when the character information is registered as the content. The tag information (main) is an example of first tag information in the present embodiment.

In addition, the tag information (sub) is a word or a phrase included in a remark of the user related to the content when the content is disclosed on the chat. Note that tag information (sub) is unregistered for content not disclosed on the chat. The tag information (sub) is an example of second tag information in the present embodiment.

Returning to FIG. 1, the chat history information 105 corresponds to information in which a remark in a chat and content registered in the chat are registered in chronological order.

Returning to FIG. 1, the communication unit 111 transmits and receives information to and from the terminal apparatus 2. For example, the communication unit 111 receives information such as character information or image information transmitted from the terminal apparatus 2. The communication unit 111 sends the received information to the reception information processing unit 112. The character information corresponds to, for example, a remark of the user. The communication unit 111 receives (acquires) one or more remarks included in the chat. Further, the communication unit 111 acquires the conversion information 103 input by the user or the content information 104 of the user from the terminal apparatus 2 and stores the obtained conversion information 103 or content information 104 in the storage unit 150. The communication unit 111 is an example of an acquisition unit in the present embodiment.

Further, the communication unit 111 transmits (outputs) a response sentence generated by the response unit 117 described later or content specified by the specification unit 116 to the terminal apparatus 2. The communication unit 111 is an example of an output unit in the present embodiment.

The reception information processing unit 112 classifies the information received by the communication unit 111 from the terminal apparatus 2 into character information and information other than the character information. The information other than the character information is, for example, information such as a picture, a moving image, music, etc. In the present embodiment, when the information received from the terminal apparatus 2 is character information, the character information is referred to as a “remark” of the user participating in the chat.

In addition, the reception information processing unit 112 authenticates the chat user based on a password input by the user of the terminal apparatus 2 and the user information 101. The reception information processing unit 112 sends a user ID of the authenticated user to the conversion unit 115.

In addition, when the user is authenticated and the information received by the communication unit 111 from the terminal apparatus 2 is character information, the reception information processing unit 112 sends the received information to the wording recognition unit 113. Further, when the user is authenticated and the information received by the communication unit 111 from the terminal apparatus 2 is information other than the character information, the reception information processing unit 112 registers the information in the chat history information 105 of the storage unit 150 in association with a user ID of a user who is a sender and a transmission time or a reception time of the information.

The wording recognition unit 113 analyzes the syntax of the character information received by the communication unit 111 from the terminal apparatus 2 and recognizes the character information as wording. In the present embodiment, the wording may correspond to one or more words or a sentence including the subject and predicate, etc. When the character information corresponds to a sentence or when a plurality of words is included in the character information, the wording recognition unit 113 divides the character information into words. The wording recognition unit 113 sends a wording recognition result to the determination unit 114 and the conversion unit 115. In addition, the wording recognition unit 113 registers the wording recognition result in the chat history information 105 in association with a user ID of a user corresponding to a sender (speaker) of the character information and a transmission time or a reception time of the character information.

The determination unit 114 determines whether or not the remark of the user participating in the chat includes the processing request expression based on the wording recognition result by the wording recognition unit 113. When any of words included in the remark of the user matches any of processing request expressions registered in the processing request information 102, the determination unit 114 determines that the processing request expression is included in the remark. When the determination unit 114 determines that the processing request expression is included in the remark of the user, the determination unit 114 sends a start of processing to be executed associated with the processing request expression and a requester of the start of the processing to the conversion unit 115 and the specification unit 116. The requester of the start of the processing corresponds to the speaker making the remark including the processing request expression.

When it is determined that the processing request expression is included in the remark, the conversion unit 115 converts a word included in the remark into one or more specifying-purpose expressions based on environment information of the chat and the conversion information 103.

For example, when a combination of a word in the remark including the processing request expression and current chat environment information matches a combination of a conversion target expression and environment information registered in the conversion information 103 associated with the user making the remark, the conversion unit 115 converts the word (conversion target expression) included in the matching combination into a specifying-purpose expression associated with the combination of the conversion target expression and the environment information.

In addition, when the content is not specified by the specification unit 116 described later, the conversion unit 115 converts a word included in remarks of another user participating in the chat (user other than the requester of the start of the processing) into a specifying-purpose expression based on a combination of a conversion target expression and environment information registered in conversion information 103 of another user.

In addition, the conversion unit 115 preferentially uses, as a search condition, a conversion target expression converted from a word having a priority that determines a priority of a word included in “the combination of the word included in the remark and the environment information of the chat” matching the “combination of the conversion target expression and the environment information” registered in the conversion information 103 in search processing by the specification unit 116 described later.

For example, the conversion unit 115 sets a high priority for a word that modifies a word that is an object of a word matching the processing request expression, and sets a low priority for a word that modifies a verb, etc. other than the processing request expression.

In addition, the conversion unit 115 excludes a word that is not associated with the specifying-purpose expression among words included in the remark of the user and a word that does not include new information from conversion targets of the specifying-purpose expression. For example, the word that does not include new information corresponds to a word indicating information previously specified by a specifying-purpose expression into which a high priority word is converted.

In addition, the conversion unit 115 excludes, from among remarks included in the chat, a remark that does not include a word associated with the specifying-purpose expression and a remark that does not include new information, from conversion targets of the specifying-purpose expression. For example, the remark that does not include new information corresponds to the same or similar word as or to a word included in a past remark of the chat or a remark that does not include information other than information previously specified by a word included in a past remark on the chat.

The conversion unit 115 sends the specifying-purpose expression corresponding to a conversion result to the specification unit 116. Note that, when a plurality of conversion target expressions is specified from one remark, the conversion unit 115 sends a specifying-purpose expression corresponding to each of the plurality of conversion target expressions to the specification unit 116.

The specification unit 116 specifies content based on one or more specifying-purpose expressions converted by the conversion unit 115. More specifically, the specification unit 116 specifies desired content of the user by searching for content information 104 associated with a user making a remark including a word of a conversion source of the specifying-purpose expression using the specifying-purpose expression as a search condition.

For example, the specification unit 116 searches for tag information (main) or tag information (sub) including a word that matches the specifying-purpose expression. When any one of the tag information (main) or the tag information (sub) includes the specifying-purpose expression, the specification unit 116 specifies content associated with the tag information (main) or the tag information (sub) as desired content of the user. The specification unit 116 may search for both the tag information (main) and the tag information (sub), or may first set the tag information (main) as a search target and set the tag information (sub) as a search target when content may not be specified.

Further, in addition to tag information (main) and tag information (sub), whose wording completely matches the wording of the specifying-purpose expression, the specification unit 116 determines tag information (main) and tag information (sub) corresponding to a lower concept of the specifying-purpose expression to be the tag information (main) and the tag information (sub) matching the specifying-purpose expression. For example, when the specifying-purpose expression corresponds to a place name, the specification unit 116 determines that a place included in the place name is included in the specifying-purpose expression.

In addition, the specification unit 116 uses specifying-purpose expressions from a specifying-purpose expression converted from a word having a high priority determined by the conversion unit 115 as a search condition.

In addition, in the case where content may not be specified, the specification unit 116 specifies content based on one or more specifying-purpose expressions converted from a word included in a remark of another user participating in the chat (user other than the requester of the start of the processing). In this case, the specification unit 116 searches for the content information 104 associated with another user.

The case where content may not be specified by the specification unit 116 (the specification unit 116 may not specify content) is set to the case where content items, the number of which is greater than or equal to a predetermined threshold value, are included in a content specification result or the case where the content specification result corresponds to 0 case.

The predetermined threshold value is set in advance by, for example, an administrator or a user of the chat server 1. A value of the predetermined threshold value is not particularly limited. Note that a threshold value serving as an upper limit for the data amount instead of the number of content items may be determined in advance.

The specification unit 116 sends the specified content to the response unit 117. When the content may not be specified, the specification unit 116 notifies the response unit 117 that the content may not be specified.

The response unit 117 generates a response sentence responding to the chat user, and outputs the response sentence to the terminal apparatus 2 via the communication unit 111. For example, the response unit 117 generates a response sentence when the content specified by the specification unit 116 is disclosed on the chat. The response unit 117 may change wording of the response sentence when the content is disclosed on the chat according to a process requested by the user. For example, the response unit 117 changes the wording of the response sentence according to whether the executed process corresponds to “search”, “collection”, or “investigation”.

In addition, when the content is not specified by the specification unit, the response unit 117 generates a response sentence for acquiring additional information from the chat user.

The response unit 117 sends the generated response sentence to the communication unit 111. In addition, the response unit 117 registers the generated response sentence in the chat history information 105 of the storage unit 150 in association with a transmission time. In addition, when a response of the content specification result is completed, the response unit 117 notifies the registration unit 118 of the completion of the response.

The registration unit 118 registers the tag information (sub) of the content information 104 based on the remark on the chat and the content disclosed on the chat. For example, when the content is disclosed on the chat, the registration unit 118 acquires a word or phrase included in the remark of the user related to the content from the chat history information 105, and saves the word or phrase in association with the content as the tag information (sub).

The registration unit 118 may register the tag information (sub) of the content information 104, for example, when the notification of the completion of the response is received from the response unit 117, or at regular intervals.

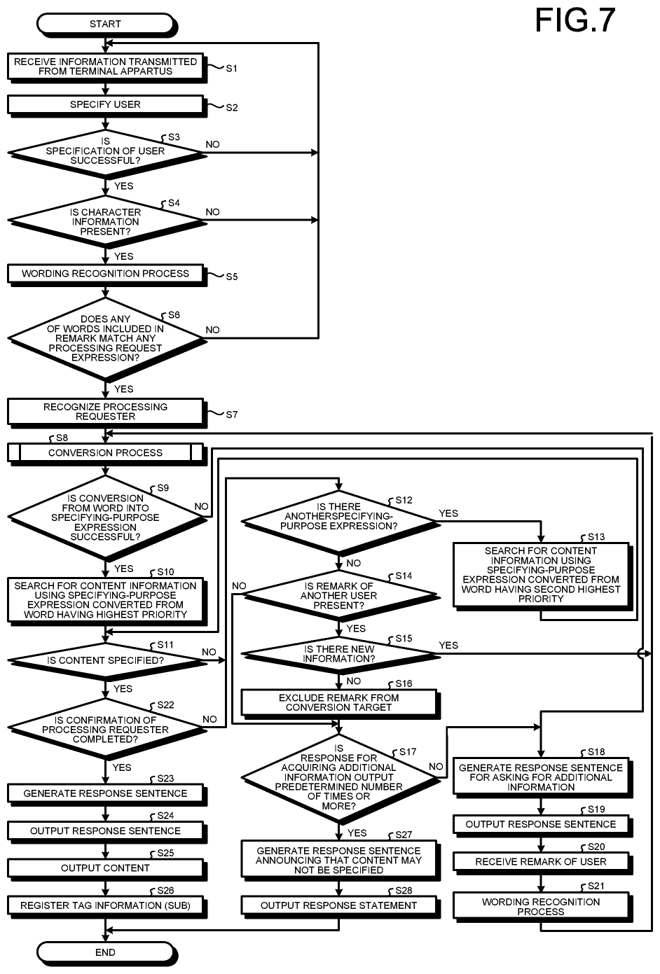

Next, a description will be given of a flow of a response process executed by the chat server 1 of the present embodiment configured as described above. FIG. 7 is a flowchart illustrating an example of the flow of the response process according to the present embodiment.

First, the communication unit 111 receives information transmitted from the terminal apparatus 2 (S1). The communication unit 111 sends the received information to the reception information processing unit 112.

Subsequently, the reception information processing unit 112 specifies a user inputting the information transmitted from the terminal apparatus 2 (S2). For example, in the case where a user participating in the chat logs in, the reception information processing unit 112 authenticates the user based on a password input to the terminal apparatus 2 corresponding to a transmission source of the information and the user information 101. In addition, in the case where the user previously logs in, each time the communication unit 111 receives information from the terminal apparatus 2, the reception information processing unit 112 specifies the user inputting the information based on an IP address of the terminal apparatus 2, etc. corresponding to a transmission source of the information.

Then, the reception information processing unit 112 determines whether or not specification of the user is successful (S3). For example, when the user inputting the information received from the terminal apparatus 2 by the communication unit 111 does not correspond to any of users registered in the user information 101, the reception information processing unit 112 determines that specification of the user is unsuccessful (S3 “No”). The reception information processing unit 112 returns to processing of S1 to exclude information that may not specify the user from the response.

In addition, upon determining that the user inputting the information received from the terminal apparatus 2 by the communication unit 111 corresponds to any of the users registered in the user information 101, the reception information processing unit 112 determines that specification of the user is successful (S3 “Yes”). In this case, the reception information processing unit 112 determines whether character information is included in the information received from the terminal apparatus 2 by the communication unit 111 (S4).

For example, when the information received from the terminal apparatus 2 by the communication unit 111 corresponds to only image information such as a picture, the reception information processing unit 112 determines that character information is not included (S4 “No”). In this case, the process returns to S1.

In addition, in the case of determining that the information received from the terminal apparatus 2 by the communication unit 111 includes the character information (S4 “Yes”), the reception information processing unit 112 sends the received information to the wording recognition unit 113.

Then, the wording recognition unit 113 executes a wording recognition process, analyzes syntax of the character information received by the communication unit 111 from the terminal apparatus 2, and recognizes the character information as wording (S5). Further, the wording recognition unit 113 divides the recognized wording in units of words.

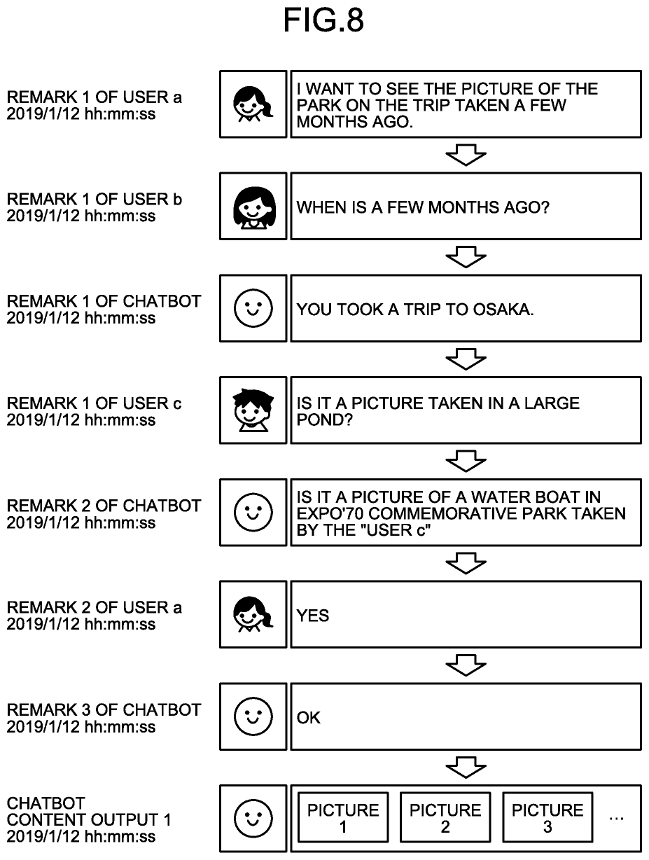

Here, an example of a chat will be specifically described. FIG. 8 is a diagram illustrating an example of the chat according to the present embodiment. In the example illustrated in FIG. 8, three users, a, b, and c, are chatting. The remark made by the “chatbot” illustrated in FIG. 8 is a response output from the chat server 1.

For example, in the case of receiving character information corresponding to a first remark of the user a “I want to see the picture of the park on the trip taken a few months ago”, the wording recognition unit 113 divides the remark into wards. In addition, the wording recognition unit 113 extracts words “few months ago”, “took”, “trip”, “park”, “picture”, and “want to see” excluding the particles from a division result.

Subsequently, the wording recognition unit 113 sends a recognition result of the wording divided into words (“few months ago”, “took”, “trip”, “park”, “picture”, and “want to see”) to the determination unit 114. In addition, the wording recognition unit 113 registers the recognition result of the wording in the chat history information 105 in association with a user ID of the user corresponding to a speaker and a transmission time of the remark.

Subsequently, the determination unit 114 determines whether any of the words included in the wording recognized by the wording recognition unit 113 matches any of the processing request expressions registered in the processing request information 102 (S6).

In the example illustrated in FIG. 8, the word “want to see” included in the first remark of the user a matches the processing request expression “want to see” registered in the processing request information 102. In this case, the determination unit 114 determines that a request to start the processing to be executed “search” associated with the processing request expression “want to see” is received. Further, the determination unit 114 recognizes the user a making the remark including the processing request expression “want to see” as a requester (processing requester) of the start of the “search” process (S7).

In the case of determining that a word included in the wording recognized by the wording recognition unit 113 matches any one of the processing request expressions registered in the processing request information 102, the determination unit 114 sends a start of processing to be executed associated with the processing request expression and a requester of the start of the processing to the conversion unit 115 and the specification unit 116.

Then, the conversion unit 115 starts a conversion process (S8).

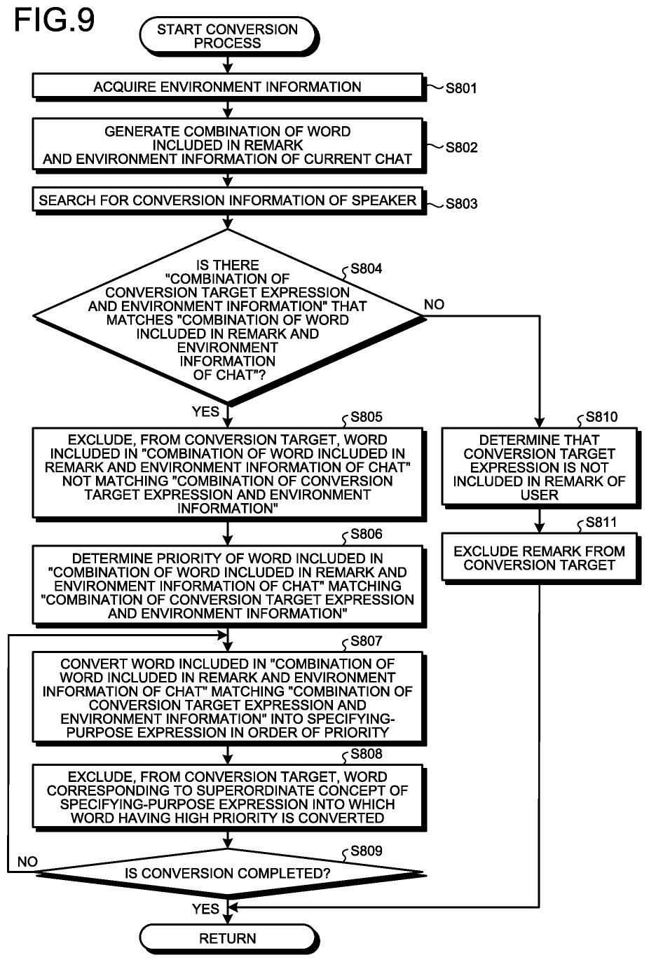

FIG. 9 is a flowchart illustrating an example of a flow of the conversion process according to the present embodiment. The conversion unit 115 acquires current chat environment information (S801). For example, in the example illustrated in FIG. 8, the conversion unit 115 acquires chat participating members “user a, user b, and user c” and a date “2019/1/12” or “2019 January” at the time of execution of the chat as the chat environment information. Note that position information of the terminal apparatus 2a used by the user a may be acquired as a current position of the user “a” and used as environment information.

Subsequently, the conversion unit 115 generates a combination of a word included in the remark of the user a and the current chat environment information (“user a, user b, user c”, “2019/1/12”) (S802). Here, the conversion unit 115 excludes the word “want to see” matching the processing request expression among the words included in the remark of the user a “few months ago”, “took”, “trip”, “park”, “picture”, and “want to see” from targets of the combination with the environmental information.

Then, the conversion unit 115 searches for a combination of the conversion target expression and the environment information of the conversion information 103a of the user a corresponding to the speaker as the generated combination (S803).

Then, the conversion unit 115 determines whether or not there is a “combination of a conversion target expression and environment information” that matches the “combination of the word included in the remark and the environment information of the chat” (S804).

In the example of the conversion information 103a illustrated in FIG. 4, a combination of a conversion target expression “trip” and environment information “user a, user b, user c” of a conversion ID “000C”, a combination of a conversion target expression “park” and environment information “user a, user b, user c” of a conversion ID “000D”, and a combination of a conversion target expression “few months ago” and environment information “January 2019” of a conversion ID “000E” match the “combination of the word included in the remark and the environment information of the chat”.

In this case, the conversion unit 115 determines that there is a “combination of a conversion target expression and environment information” that matches the “combination of the word included in the remark and the environment information of the chat” (S804 “Yes”).

Subsequently, the conversion unit 115 excludes the word included in the “combination of the word included in the remark and the environment information of the chat” not matching the “combination of the conversion target expression and the environment information” from conversion targets (S805). For example, in the examples illustrated in FIG. 4 and FIG. 8, the words “took” and “picture” included in the remark do not match any of the conversion target expressions registered in the conversion information 103a. For this reason, the conversion unit 115 excludes “took” and “picture” from conversion targets. In addition, even when a word matches any one of the conversion target expressions registered in the conversion information 103a, if the environment information of the chat does not match the environment information registered in the conversion information 103a, the conversion unit 115 excludes the word from the conversion targets.

Subsequently, the conversion unit 115 determines a priority of a word included in the “combination of the word included in the remark and the environment information of the chat” matching the “combination of the conversion target expression and the environment information” (S806).

In the example illustrated in FIG. 8, the conversion unit 115 sets a high priority for “park” or “trip” that modifies the word “picture” corresponding to an object of the word “want to see” matching the processing request expression among “few months ago”, “trip” and “park”. In addition, the conversion unit 115 sets a low priority for the word “few months ago” that modifies the verb “took” other than the processing request expression. Note that a criterion for the priority is not limited thereto.

In addition, when there is a plurality of words having the same grammatical priority, the conversion unit 115 may determine the priority based on the order used in the remark, the order of conversion IDs of the conversion information 103, etc.

In the example illustrated in FIG. 8, the conversion unit 115 determines that “trip” has a highest priority, “park” has a second highest priority, and “few months ago” has a lowest priority.

Subsequently, the conversion unit 115 converts the word included in the “combination of the word included in the remark and the environment information of the chat” matching the “combination of the conversion target expression and the environment information” into a specifying-purpose expression in the order of priority (S807). For example, in the example illustrated in FIG. 8, among “trip”, “park”, and “few months ago”, the conversion unit 115 first converts “trip” into a specifying-purpose expression “2018/10/10, Osaka”.

Subsequently, the conversion unit 115 excludes, from conversion targets, a word corresponding to a superordinate concept of a specifying-purpose expression into which a word having a high priority is converted among conversion target words (S808). For example, in the example illustrated in FIG. 8, the word “few months ago” is an upper concept of “2018/10/10” of the specifying-purpose expression “2018/10/10, Osaka” into which “trip” is converted, and does not include new information. In this case, the conversion unit 115 excludes the word “few months ago” from the conversion targets.

Note that “corresponding to an upper concept of a specifying-purpose expression into which a word having a high priority is converted” is an example of not including new information, and the conversion unit 115 may specify a word that does not include new information according to another condition.

Subsequently, the conversion unit 115 determines whether or not conversion of the word to be converted is completed (S809). When conversion of the word to be converted is not completed (S809 “No”), the conversion unit 115 returns to processing of S807. Here, the conversion unit 115 converts the last remaining “park” into specifying-purpose expressions “Ueno Park”, “Expo '70 Commemorative Park”, and “Satsukiyama Park”.

When conversion of the word to be converted is completed (S809 “Yes”), the conversion unit 115 returns to processing of the flowchart illustrated in FIG. 7. In addition, the conversion unit 115 sends the specifying-purpose expressions corresponding to a conversion result to the specification unit 116 in association with the conversion source word and priority.

In addition, when there is no “combination of a conversion target expression and environment information” that matches the “combination of the word included in the remark and the environment information of the chat” (S804 “No”), the conversion unit 115 determines that the conversion target expression is not included in the remark of the user (S810). In this case, the conversion unit 115 excludes the remark from the conversion target (S811). In addition, the conversion unit 115 notifies the specification unit 116 that the remark is excluded from the conversion target. Then, the process returns to processing of the flowchart illustrated in FIG. 7.

After completion of the conversion process of S8, the specification unit 116 determines whether or not conversion from the word into the specifying-purpose expression is successful (S9).

In the case of acquiring the specifying-purpose expression from the conversion unit 115, the specification unit 116 determines that conversion from the word into the specifying-purpose expression is successful (S9 “Yes”). In this case, the specification unit 116 searches for the content information 104 using a specifying-purpose expression converted from a word having a highest priority (S10). In addition, the content information 104 to be searched corresponds to content information 104 associated with the user (processing requester) making the remark that includes the processing request expression.

In the example of the conversation illustrated in FIG. 8, since the processing requester is the user a, a search target corresponds to the content information 104a. The specification unit 116 searches for tag information (main) and tag information (sub) of the content information 104a using the specifying-purpose expression “2018/10/10, Osaka” converted from the word “trip” having the highest priority. Since “2018/10/10” and “Osaka” correspond to AND conditions, the specification unit 116 searches for tag information (main) or tag information (sub) including both the words. In addition, the specification unit 116 determines that Osaka is a place name, and searches for a place name or location information included in Osaka Prefecture (or Osaka City).

In the example of the content information 104a illustrated in FIG. 6, three content items of a content ID “0001”, a content ID “0002”, and a content ID “0005” are acquired as search results. Specifically, “2018/10/10” and “Expo '70 Commemorative Park” in Osaka of tag information (sub) of the content ID “0001” match the specifying-purpose expressions. In addition, “2018/10/10” and “Kaiyukan” in Osaka of tag information (sub) of the content ID “0002” match the specifying-purpose expressions. In addition, “2018/10/10” and “Expo '70 Commemorative Park” of tag information (sub) of the content ID “0005” match the specifying-purpose expressions.

Note that the specification unit 116 may determine that the type of the content to be searched for is “picture” from the remark of the user “a” including the processing request expression “I want to see the picture of the park on the trip taken a few months ago”, and set only content including “picture” in the tag information (main) as a search target.

Then, the specification unit 116 determines whether or not the content is specified (S11). For example, in the case where content items, the number of which is greater than or equal to a predetermined threshold value, are included in a content specification result or the case where the content specification result corresponds to 0 case, the specification unit 116 determines that the content may not be specified (S11 “No”).

In the present embodiment, as an example, the predetermined threshold value is set to “2”. In the example of the content information 104a illustrated in FIG. 6, since three content items are acquired as search results, the specification unit 116 determines that the content may not be specified.

In this case, the specification unit 116 determines whether or not there is another specifying-purpose expression (S12). When there is another specifying-purpose expression acquired from the conversion unit 115 (S12 “Yes”), the specification unit 116 searches for the content information 104a using a specifying-purpose expression converted from a word having a second highest priority (S13).

Since the word having the second highest priority after “trip” is “park”, the specification unit 116 searches for tag information (main) and tag information (sub) of the content information 104a using specifying-purpose expressions “Ueno Park”, “Expo '70 Commemorative Park”, and “Satsukiyama Park” converted from “park”. In addition, since “Ueno Park”, “Expo '70 Commemorative Park”, and “Satsukiyama Park” correspond to OR conditions, the specification unit 116 searches for tag information (main) and tag information (sub) including at least one of these specifying-purpose expressions.

In addition, the specification unit 116 may exclude a place name or position information not corresponding to “Osaka” previously used as a search condition from the search conditions. For example, since “Ueno Park” is located in Tokyo, the specification unit 116 excludes “Ueno Park” from the search condition.

When the specification unit 116 performs searching using “Expo '70 Commemorative Park” or “Satsukiyama Park”, two content items of the content ID “0001” and the content ID “0005” are acquired as search results.

Then, the specification unit 116 returns to processing of S11 and determines whether or not the content is specified. Since the number of content items included in the search results is greater than or equal to the predetermined threshold value, the specification unit 116 determines that the content is not specified (S11 “No”) and proceeds to processing of S12.

In the case of determining that it is clear that the number of content items included in the search results is greater than or equal to the predetermined threshold value, the specification unit 116 may proceed to processing of S12 without executing processing of S10 and S11. For example, the case where it is clear that the number of content items included in the search results is greater than the predetermined threshold value corresponds to the case where a specifying-purpose expression serving as a search condition is a general word as metadata such as a picture.

When it is determined that there is no other specifying-purpose expression acquired from the conversion unit 115 (S12 “No”), the specification unit 116 determines whether or not there is a remark of another user, that is, a user other than the processing requester (S14). For example, the specification unit 116 determines whether or not there is a remark of a user other than the processing requester based on the chat history information 105.

For example, in the example illustrated in FIG. 8, the user b makes a remark “when is a few months ago?”. In this case, the specification unit 116 determines that there is a remark of another user (S14 “Yes”). In the example illustrated in FIG. 8, after a remark 1 of the user a corresponding to the processing requester, the user b makes a remark. However, even when a user other than the processing requester makes a remark before the remark of the user a, the specification unit 116 determines that there is a remark of another user. In addition, it is presumed that wording of the remark is recognized by the wording recognition unit 113. The specification unit 116 sends the remark of another user to the conversion unit 115.

In this case, the conversion unit 115 determines whether or not the remark of another user includes new information (S15). For example, when a word included in the remark by another user corresponds to the same or similar word as or to the word included in the remark of the processing requester or an upper concept of the word included in the remark of the processing requester, the conversion unit 115 determines that the remark by another user does not include new information (S15 “No”). In addition, when a word included in the remark by another user corresponds to the same or similar word as or to a specifying-purpose expression previously used as a search condition or an upper concept of a specifying-purpose expression previously used as a search condition, the conversion unit 115 determines that the remark by another user does not include new information.

The words “few months ago” included in a remark 1 of the user b illustrated in FIG. 8 are included in the remark 1 of the user a corresponding to the processing requester. For this reason, the conversion unit 115 determines that the remark 1 of the user b does not include new information and excludes the remark from the conversion target (S16).

In addition, in the case of determining that the remark by another user includes new information (S15 “Yes”), the conversion unit 115 starts the conversion process of S8. Processing of S15 and S16 may be executed by the specification unit 116.

Subsequent to processing of S16, the specification unit 116 notifies the response unit 117 that the content may not be specified. In this case, the response unit 117 determines whether or not a response for acquiring additional information is output a predetermined number of times or more (S17).

The predetermined number of times corresponds to an upper limit of the number of responses for asking for additional information, and is predetermined in advance by, for example, an administrator or a user of the chat server 1. Note that it is possible to adopt a configuration in which the upper limit of the number of responses for asking for additional information is not determined and the response is continued until the content is specified.

In addition, in the case of determining that there is no remark of another user (S14 “No”), the specification unit 116 notifies the response unit 117 that the content may not be specified and proceeds to processing of S17.

In the case of determining that the response for asking for additional information is not output a predetermined number of times or more (S17 “No”), the response unit 117 generates a response sentence for asking for additional information (S18). The response unit 117 creates a response sentence by combining a currently specified specifying-purpose expression or a word included in the remark of the processing requester. The response sentence of this case may correspond to a question sentence or a sentence having content that urges the user to make a remark in a format other than a question sentence.

The response unit 117 sends the generated response sentence to the communication unit 111. The communication unit 111 outputs the response sentence to the terminal apparatus 2 (S19).

For example, in the example illustrated in FIG. 8, the response unit 117 combines “trip” having the highest priority among words included in the remark 1 of the user “a” and a specifying-purpose expression “Osaka” converted from “trip” to generate a response sentence “You took a trip to Osaka”. The response sentence is an example and is not limited thereto.

In addition, in the case of executing a response for asking for additional information a plurality of times, the response unit 117 may include words included in the remark 1 of the user “a” in the response sentence in descending order of priority. For example, since a word having a second highest priority after “trip” is “park”, the response unit 117 may generate a sentence “You went to parks like Ueno Park, Expo '70 Commemorative Park, and Satsukiyama Park” as a subsequently output response sentence.

In the example illustrated in FIG. 8, in response to the response sentence, the user c makes a remark “Is it a picture taken in a large pond?”. As the remark, the communication unit 111 acquires a remark after the response sentence output in S19. Specifically, the communication unit 111 receives character information of the remark from the terminal apparatus 2c (S20). The communication unit 111 sends the received character information to the reception information processing unit 112.

Then, the wording recognition unit 113 executes a wording recognition process on the remark of the user c (S21). In addition, the wording recognition unit 113 sends the wording recognition result to the conversion unit 115. Subsequently, the conversion unit 115 returns to S8 and executes a conversion process.

Details of processing of S8 has been described in FIG. 9, and thus a description thereof will be omitted. However, the conversion unit 115 combines the word “pond” included in the remark 1 “Is it a picture taken in a large pond?” of the user c and current chat environment information “user a, user b, and user c” to search for conversion information 103c of the user c. As illustrated in FIG. 5, the conversion information 103c includes a specifying-purpose expression “Expo '70 Commemorative Park, water boat” associated with a combination of a conversion target expression “pond” and environment information “user a, user b, user c”.

The specification unit 116 searches for content information 104a of the user a corresponding to the processing requester using the specifying-purpose expression “Expo '70 Commemorative Park” and “water boat” converted by the conversion information 103c of the user c as an AND condition. Here, the content information 104a includes only one content item including both “Expo '70 Commemorative Park” and “water boat” in tag information (sub). In this case, since a search result does not correspond to 0 and the number of content items included in the search result is less than a predetermined threshold value, the specification unit 116 determines that content can be specified (S11 “Yes”). In this case, the specification unit 116 sends the specified content to the response unit 117.

Subsequently, the response unit 117 verifies whether the specified content corresponds to content desired by the processing requester for the processing requester. For example, as illustrated in FIG. 8, the response unit 117 generates a response sentence “Is it a picture of a water boat in Expo '70 Commemorative Park taken by the “user c”?” for specifying the content. In the example illustrated in FIG. 8, since the user a corresponding to the processing requester replies “Yes” to the response sentence, the response unit 117 determines that confirmation of the processing requester is completed (S22 “Yes”).

For example, in the case where the user “a” replies “No, wrong”, the response unit 117 determines that confirmation of the processing requester is not completed (S22 “No”). In this case, the process proceeds to processing of S12, and the above process is repeated.

In the case of S22 “Yes”, the response unit 117 generates a response sentence when the content specified by the specification unit 116 is disclosed on the chat (S23). Further, the communication unit 111 outputs the response sentence (S24). In the example illustrated in FIG. 8, the response sentence is “OK” as an example. However, the response sentence is not limited thereto. For example, when the executed process is “search”, the response unit 117 may generate a response sentence such as “Report the search result”.

Then, the response unit 117 outputs the content specified by the specification unit 116 via the communication unit 111 (S25). In the example illustrated in FIG. 8, the response unit 117 discloses “picture 1”, “picture 2”, and “picture 3” registered in the content information 104a on the chat.

Subsequently, the registration unit 118 registers the tag information (sub) of the content information 104 based on the remark on the chat and the content published in the chat (S26). For example, the registration unit 118 may add “large pond” included in the remark 1 of the user c to tag information (sub) associated with “picture 1”, “picture 2”, and “picture 3” in the content information 104a.

In addition, in the case of determining that the response for asking for additional information is output a predetermined number of times or more (S17 “Yes”), the response unit 117 generates a response sentence announcing that the content may not be specified (S27). Then, the communication unit 111 outputs the response sentence (S28). Here, processing of this flowchart ends.

As described above, when it is determined that the processing request expression is included in the remark of the user participating in the chat, the chat server 1 of the present embodiment converts the word included in the remark into one or more specifying-purpose expressions based on environment information indicating the environment of the chat and the conversion information 103 associated with the user making the remark, and specifies content based on the converted specifying-purpose expressions. Since the word included in the remark of the user changes depending on the context, etc., the word may not be suitable for the search condition of the content desired by the user. However, the chat server 1 of the present embodiment converts the word included in the remark based on the environment information indicating the environment of the chat and the conversion information 103 associated with the user, and thus it is possible to search for the content using a specifying-purpose expression suitable for the environment of the chat and the speaker. For this reason, according to the chat server 1 of the present embodiment, information desired by the user can be specified with high accuracy.

In addition, the chat server 1 according to the present embodiment starts processing for specifying the content when it is determined that the processing request expression is included in the remark of the user participating in the chat. Thus, even when the user of the chat does not perform an operation of starting a separate process, it is possible to provide desired information to the user.

In addition, the environment information of the present embodiment corresponds to information indicating a combination of users participating in the chat or a date when the chat is performed. Further, when a combination of a word in a remark including a processing request expression and environment information of a conversation including the remark matches a combination of environment information and a conversion target expression registered in the conversion information 103 associated with a user making the remark, the chat server 1 of the present embodiment converts a word included in the matching combination into one or more specifying-purpose expressions associated with a combination of environment information and a conversion target expression matching the word. For example, even the same word may have different meanings depending on the conversation partner. Further, words such as “few months ago” indicating a time or a period may indicate different times depending on the date when the chat is performed. According to the chat server 1 of the present embodiment, the words included in the remark are converted into different specifying-purpose expressions according to the members participating in the chat or the dates, so that it is possible to perform an information search according to the intention of the user.

In addition, when the content is not specified, the chat server 1 of the present embodiment generates and outputs a response sentence for acquiring additional information from the user, and acquires a remark after the response sentence. For this reason, according to the chat server 1 of the present embodiment, even when information for specifying content is insufficient in the first remark of the user, it is possible to improve a probability that the content can be specified by additionally acquiring information.

In addition, when content may not be specified based on one or more specifying-purpose expressions converted from a word included in a remark of a user making the remark including a processing request expression, the chat server 1 of the present embodiment specifies the content based on one or more specifying-purpose expressions converted from a word included in a remark of another user participating in the chat. For this reason, according to the chat server 1 of the present embodiment, it is possible to improve a probability that the content can be specified by acquiring information from a user other than a user desiring specification of the content.

In addition, the chat server 1 of the present embodiment excludes a word that is not associated with the specifying-purpose expression among words included in the remark of the user and a word that does not include new information from conversion targets of the specifying-purpose expression. A word that does not include the word that is not associated with the specifying-purpose expression and a word that does not include the new information may correspond to noise of a process when content is specified or may not contribute to narrowing down search targets. For this reason, the chat server 1 of the present embodiment excludes a word which is likely to correspond to such noise from the conversion targets, thereby selecting an effective word for specifying the content, and can more efficiently perform the content specification process.

In addition, the chat server 1 of the present embodiment excludes, from conversion targets of a specifying-purpose expression, a remark that does not include a word associated with the specifying-purpose expression and a remark that does not include new information among remarks included in a chat. By not only excluding words, but also excluding a remark from conversion targets, it is possible to more efficiently specify content.

In addition, the chat server 1 of the present embodiment specifies content by searching for content information 104 associated with each user as a search condition of a specifying-purpose expression. In addition, the tag information (main) of the content information 104 corresponds to metadata of the content, and the tag information (sub) corresponds to a word included in a remark related to the content in the chat. According to the chat server 1 of the present embodiment, by associating a remark related to content in a chat with the content in the content information 104, it is possible to more easily specify desired content from the remark of the user.

In the present embodiment, a conversation including remarks of a plurality of users is taken as an example. However, the chat server 1 is applicable to a conversation in which one user and a chatbot have a one-to-one conversation.

First Modification

In the above-described embodiment, the chat server 1 provides the chat environment and has a specific function of the response and the content. However, the invention is not limited to this configuration. For example, it is possible to adopt a configuration in which the chat server 1 accesses a chat environment provided by another device and specifies a response and content.

Second Modification

In the above embodiment, the conversion information 103 and the content information 104 are saved in the storage unit 150 of the chat server 1. However, the conversion information 103 and the content information 104 may be saved in the terminal apparatus 2 used by each user. When this configuration is adopted, the conversion unit 115 communicates with the terminal apparatus 2 via the communication unit 111, and executes word conversion based on the conversion information 103 saved in the terminal apparatus 2. In addition, the specification unit 116 communicates with the terminal apparatus 2 via the communication unit 111, and searches for the content information 104 stored in the terminal apparatus 2.

Third Modification

In the above-described embodiment, the conversion information 103 and the content information 104 are generated as individual databases for each chat user. However, it is sufficient that the conversion information 103 and the content information 104 are associated with each user, and the invention is not limited to this configuration. For example, it is possible to adopt a configuration in which conversion information or content information of all users is stored in one database using user IDs of the users as keys.

Fourth Modification

In the above-described embodiment, the specification unit 116 searches for the content information 104 of the processing requester. However, a search destination is not limited thereto. For example, the specification unit 116 may search for content information 104 of a user other than the processing requester. In addition, the specification unit 116 may search for information disclosed on the Internet.

Fifth Modification

In the above-described embodiment, “search”, “collection”, and “investigation” are registered as processing to be executed in the processing request information 102. However, other processing may be further registered. For example, processing such as “confirmation” may be registered.

Sixth Modification

In the above-described embodiment, the conversion information 103 is registered by a chat user. However, a method of registering the conversion information 103 is not limited thereto. For example, the registration unit 118 of the chat server 1 may register the conversion information 103 based on a remark on the chat, and the tag information (main) or the tag information (sub) of the content information 104.

Seventh Modification

In the above-described embodiment, the input device 22 of the terminal apparatus 2 is, for example, a keyboard, a mouse, a touch panel, etc. However, the terminal apparatus 2 may have a function of character input by voice. In this case, a microphone that can input voice of the user may be used as the input device 22.

Eighth Modification

In addition, in the above-described embodiment, the chat server 1 is described as having a text conversation with the user, that is, a text chat. However, the chat server 1 may have a conversation with the user directly by voice output. In this case, the response unit 117 of the chat server 1 may output the generated response sentence by voice.

The information processing program executed by the chat server 1 of the present embodiment is a file in an installable format or an executable format and is provided by being recorded on a computer-readable recording medium such as a CD-ROM, a flexible disk (FD), a CD-R, a digital versatile disk (DVD), etc.

Further, the information processing program executed by the chat server 1 of the present embodiment may be stored on a computer connected to a network such as the Internet and provided by being downloaded via the network. Further, a program of the present embodiment, which is executed by the apparatus, may be provided or distributed via a network such as the Internet. Further, the information processing program executed by the chat server 1 of the present embodiment may be configured to be provided by being incorporated in a ROM, etc. in advance.

The information processing program executed by the chat server 1 of the present embodiment has a module configuration including the above-described units (the communication unit, the reception information processing unit, the wording recognition unit, the determination unit, the conversion unit, the specification unit, the response unit, and the registration unit). In actual hardware, when the CPU (processor) reads the information processing program from the storage medium and executes the read information processing program, each of the above-described units is loaded on a main storage device, and the communication unit, the reception information processing unit, the wording recognition unit, the determination unit, the conversion unit, the specification unit, the response unit, and the registration unit are generated on the main storage device.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. An information processing apparatus comprising:
a processor that:
acquires one or more remarks included in a conversation;
determines whether or not a predetermined expression is included in the one or more remarks of one or more users participating in the conversation;
in response to a determination that the predetermined expression is included in a remark of the one more remarks, converts, based on environment information and conversion information, a word included in the remark into one or more specifying-purpose expressions, the environment information indicating an environment of the conversation, the conversion information defining a conversion rule for a word according to the environment information for each of the one or more users;
specifies content based on the one or more specifying-purpose expressions; and
outputs a specification result of the content.

2. The information processing apparatus according to claim 1,
wherein the environment information corresponds to information indicating a combination of one or more users participating in the conversation or a date of the conversation,
the conversion information corresponds to information in which a conversion target expression, the environment information, and the one or more specifying-purpose expressions are associated with each of the one or more users, and
when a combination of a word in the remark including the predetermined expression and environment information of a conversation including the remark matches a combination of the conversion target expression and the environment information, the conversion target expression being registered in the conversion information associated with a user making the remark, the processor converts the word included in the matching combination into the one or more specifying-purpose expressions associated with the combination of the conversion target expression matching the word and the environment information.

3. The information processing apparatus according to claim 1, wherein
the processor further:
generates a response sentence for acquiring additional information from the one or more users when the content is not specified;
outputs the generated response sentence; and
acquires a remark after the response sentence.

4. The information processing apparatus according to claim 1, wherein after failing to specify the content based on the one or more specifying-purpose expressions converted from the word included in the remark of a user making the remark including the predetermined expression, the processor specifies the content based on the one or more specifying-purpose expressions converted from a word included in a remark of another user participating the conversation.

5. The information processing apparatus according to claim 1, wherein the processor excludes, from a conversion target of the one or more specifying-purpose expression, a word not associated with the one or more specifying-purpose expressions and a word including no new information among words included in the remark of the user.

6. The information processing apparatus according to claim 1, wherein the processor excludes, from a conversion target of the one or more specifying-purpose expressions, a remark that does not include a word associated with the one or more specifying-purpose expressions and a remark that does not include new information among remarks included in the conversation.

7. The information processing apparatus according to claim 1,
wherein the processor specifies the content by searching content information in which the content, first tag information, and second tag information are associated with each of the one or more users, using the one or more specifying-purpose expressions as a search condition,
the first tag information corresponds to metadata of the content, and
the second tag information corresponds to a word included in a remark related to the content in the conversation.

8. A computer program product including programmed instructions embodied in and stored on a non-transitory computer readable medium, wherein the instructions, when executed by a computer, cause the computer to perform:
acquiring one or more remarks included in a conversation;
determining whether or not a predetermined expression is included in the one or more remarks of one or more users participating in the conversation;
in response to a determination that the predetermined expression is included in a remark of the one or more remarks, converting, based on environment information and conversion information, a word included in the remark into one or more specifying-purpose expressions, the environment information indicating an environment of the conversation, the conversion information defining a conversion rule for a word according to the environment information for each of the one or more users;
specifying content based on the one or more specifying-purpose expressions; and
outputting a specification result of the content.

9. A non-transitory computer readable medium storing a data structure of conversion information, the data structure used in a computer including a controller and the non-transitory computer readable medium, wherein
in the data structure
a conversion target expression,
environment information indicating an environment of a conversation of one or more users, and
one or more specifying-purpose expressions used for specifying content
are associated with each of the one or more users, and
the data structure is used in a process in which the controller acquires, from the non-transitory computer readable medium, a specifying-purpose expression associated with a combination of the conversion target expression and the environment information, the combination matching a combination of a word included in a remark of the one or more users participating in the conversation and environment information indicating an environment of the conversation.
